(19) United States
(12) Patent Application Publication
(10) Pub. No.: US 2007/0243089 A1
(43) Pub. Date: Oct. 18, 2007

(54) Check Valve for Displacement-Type Pump

(76) Inventors: Hiroaki Usui, Ueda-shi (JP); Fumihiro Yaguchi, Ueda-shi (JP)

Correspondence Address: BIRCH STEWART KOLASCH & BIRCH, PO BOX 747, FALLS CHURCH, VA, 22040-0747, US

(21) Appl. No.: 11/578,795

(22) PCT Filed: Apr. 4, 2005
(86) PCT No.: PCT/JP05/06591

§ 371 Date: Oct. 18, 2006

(30) Foreign Application Priority Data
Apr. 19, 2004 (JP) 2004-122610

(51) Int. Cl. F04B 39/00; F16K 1/42

(52) U.S. Cl. 417/559; 251/359

(57) ABSTRACT

The present invention provides a check valve for a displacement-type pump, in which fluid pressure loss is reduced and which increases pump efficiency. The check valves are arranged in direction opposite to each other on the fluid discharge side and the fluid suction side of a pump chamber 22b, valve bodies 40 are opened and closed only by fluid pressure flowing into or flowing out form the pump chamber 22b, each of the valve bodies 40 has one axis in parallel with a flow path of the fluid, and a planar outer profile of the valve body is formed into a circular shape with the axis as the center.

### FIELD OF TECHNOLOGY

The present invention relates to a check valve for a displacement-type pump, more precisely relates to a check valve for a displacement-type pump which is capable of discharging and sucking fluid by varying volume of a pump chamber so as to flow fluid, e.g., gas, liquid.

### BACKGROUND TECHNOLOGY

In a displacement-type pump capable of discharging and sucking fluid by varying volume of a pump chamber, the fluid can be sucked into the pump chamber and discharged therefrom by, for example, reciprocally moving a moving member in the pump chamber. Check valves are arranged in direction opposite to each other in a flow path (an opening section of a cylinder) for sucking the fluid into the pump chamber and discharging the fluid therefrom. Generally, various types of check valves are used—such as: a valve (not shown), in which a valve body is turned about a fulcrum shaft, e.g., pin, so as to open and close the flow path; a swing valve shown in FIG. 6A, in which an elastically deformable valve body 101, e.g., rubber plate, is capable of opening and closing a valve seat 102 formed in an opening section of a cylinder; a ball valve shown in FIG. 6B (see Patent Document 1), in which a spherical valve body 105 is provided to a valve seat 104 formed in an inner wall of a cylinder chamber 103 and freely moved in the cylinder chamber by fluid pressure; a forced valve shown in FIG. 6C (see Patent Document 2), in which a valve seat 108 is closed by a valve body 106, e.g., steel ball, biased by a coil spring 107 and opened by fluid pressure; and an electromagnetic valve (not shown), in which a valve seat is opened by a valve body (movable member), which is actuated by electromagnetic force.

Patent Document 1: JP 7-145871

Patent Document 2: JP 10-220605

### DISCLOSURE OF THE INVENTION

In case of using the swing valve shown in FIG. 6A, the valve body 101 is repeatedly deformed to open and close the valve seat, elastic fatigue is easily occurred therein, and the open-close action of the valve cannot be maintained due to a short life span, so that reliability of the valve is lowered. In cases of using the ball valves shown in FIGS. 6B and 6C, the spherical valve bodies 105 and 106 must be manufactured with high accuracy, the fluid will leak or uneven abrasion will occur according to seating positions of the valve bodies 105 and 106, and the valves cannot sufficiently work if they are manufactured with low form accuracy, so that production cost must be increased. To accommodate the ball-shaped valve bodies, volume of the cylinder chambers must be large, so that it is difficult to downsize the valve bodies and the cylinder chambers. In case of using the forced valve shown in FIG. 6C, the valve is opened and closed by external force, fluid pressure rapidly varies with the open-close action of the valve, and pressure loss is great, so that pump efficiency of a small pump will be remarkably lowered. Further, in case of using the electromagnetic valve, its structure is complex, and number of parts must be increased, so that it is difficult to downsize the valve and reduce production cost.

The present invention has been studied to solve the above described problems, and an object of the present invention is to provide a check valve for a displacement-type pump capable of reducing fluid pressure loss and improving pump efficiency.

To achieve the object, the present invention has following structures.

The check valve for a displacement-type pump, in which a movable member is reciprocally moved in a pump chamber so as to repeatedly discharging and sucking fluid, is characterized in that the check valves are arranged in direction opposite to each other on the fluid discharge side and the fluid suction side of the pump chamber, that valve bodies are opened and closed only by pressure of the fluid flowing into or flowing out from the pump chamber, that each of the valve bodies has one axis in parallel with a flow path of the fluid, and that a planar outer profile of the valve body is formed into a circular shape with the axis as the center.

The check valve is characterized in that the valve body includes: a valve section being capable of seating onto a valve seat so as to close the flow path; and a stopper section preventing the valve body from disengaging from the valve seat by the fluid pressure.

The check valve is characterized in that the valve body is constituted by a plurality of parts including a valve section, which is capable of moving to and away from a valve seat, and other sections.

The check valve is characterized in that a valve section and a stopper section of the valve body are made of different materials or rubber materials having different hardness.

The check valve is characterized in that a guide section, which is capable of guiding the open-close action with aligning an axis of a stopper section and a center of the fluid flow, is provided in the vicinity of an opening section of a valve seat.

The check valve is characterized in that the valve body is moved to and away from a seat section of a valve seat, and the seat section has a tapered face or a rounded face.

The check valve is characterized in that a valve section of the valve body, which is moved to and away from a valve seat, has a tapered face or a rounded face.

Further, the check valve is characterized in that a wall face of an opening section of the pump chamber, to which the valve body is provided, is formed into a tapered face or a rounded face.

### EFFECTS OF THE INVENTION

In the above described check valve for a displacement-type pump, the valve body is opened and closed only by the pressure of the fluid sucked into and discharged from the pump chamber, so that the pump can be downsized and pressure loss of the fluid passing the valve body can be reduced.

Since the valve body has one axis in parallel with the flow path of the fluid and the planar outer profile of the valve body is formed into the circular shape with the axis as the center, the valve body has no directional character so that the valve body can be securely seated to close the valve even if the axis of the valve body, which is moved to open by pressure variation of the fluid, is temporally inclined. Unlike ball valves, high manufacturing accuracy is not required, so that the pump chamber with good sealing capability can be achieved with low cost; no parts repeatedly slid and deformed are used, so that the valve body can be used for a prolonged period of time.

Since the valve body includes the valve section capable of seating onto the valve seat so as to close the flow path and the stopper section preventing the valve body from flushing out by the fluid pressure, parts having required characteristics for the valve section and the stopper section can be employed. The same goes for the case, in which the valve body is constituted by a plurality of the parts including the valve section, which is capable of moving to and away from the valve seat, and other sections.

Concretely, the valve section of the valve body may be made of a flexible material (e.g., plastic, elastomer, soft rubber), which is easily elastically deformed, so as to improve sealing property; the stopper section may be made of a nonflexible material (e.g., plastic, hard rubber) so as to securely engage.

Since the guide section, which is capable of guiding the open-close action with aligning the axis of the stopper section and the center of the fluid flow, is provided in the vicinity of the opening section of the valve seat, the action of the stopper section is guided by the guide section, so that posture of the valve body can be stabilized when the check valve is opened and closed. By aligning the axis of the stopper section and the center of the fluid flow, the action of the valve body can be stabilized and characteristics of the pump can be improved.

Since the seat section of the valve seat has the tapered face or the rounded face, or the valve section of the valve body has the tapered face or the rounded face, the flow path is not extremely widened or narrowed so that pressure loss, which occurs at a widened or narrowed part, can be reduced and pump efficiency can be improved.

Further, by forming the wall face of the opening section of the pump chamber, to which the valve body is provided, into the tapered face or the rounded face, loss of pressure applied from the flow path to the fluid passing through the narrow opening section of the pump chamber can be reduced, so that pump efficiency can be improved.

### BRIEF DESCRIPTION OF THE DRAWINGS

FIG. 1 is a sectional view showing an entire structure of an electromagnetic displacement-type pump relating to the present invention.

FIG. 2A-FIG. 2C is explanation views of a check valve.

FIG. 3A and FIG. 3B are explanation views of a check valve having another structure.

FIG. 4A and FIG. 4B are explanation views of a check valve having yet another structure.

FIG. 5A and FIG. 5B are sectional views of an opening section of a pump chamber having another structure.

FIG. 6A-FIG. 6C are explanation views of the structure of the conventional check valve.

### PREFERRED EMBODIMENTS OF THE INVENTION

Preferred embodiments of a check valve for a displacement-type pump of the present invention will now be described in detail with reference to the accompanying drawings. In the following description, an electromagnetic displacement-type pump will be explained as an example of the displacement-type pump. In the electromagnetic displacement-type pump of the embodiment, a moving member having a magnet (permanent magnet) is provided in a circular cylinder and capable of sliding in an axial direction of the cylinder, electromagnetic force of electromagnetic coils circularly arranged around the cylinder are applied to the movable member, and pumping action is performed by reciprocally moving the movable member.

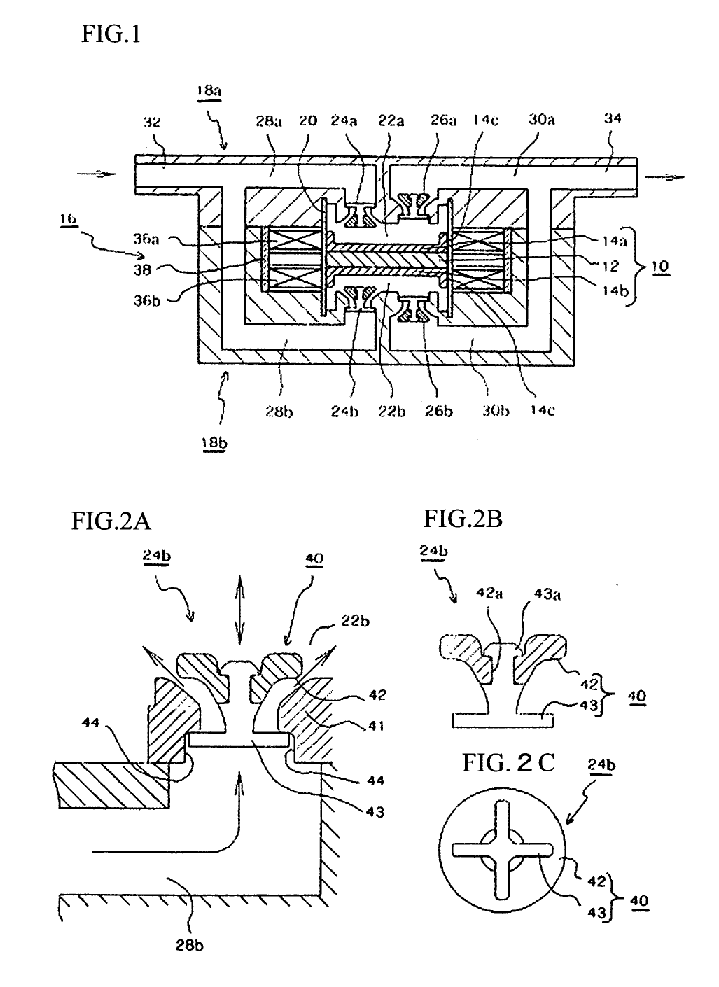

An entire structure of the electromagnetic displacement-type pump will be explained with reference to FIG. 1. Firstly, the movable member 10 will be explained. The movable member 10 is accommodated in a cylinder enough sealed and capable of reciprocally moving in the axial direction of the cylinder. The movable member 10 includes a magnet 12, which is formed into a circular plate, and a pair of inner yokes 14a and 14b, which sandwich the magnet 12 in the thickness direction. The permanent magnet 12 is magnetized in the thickness direction (in the top-bottom direction in FIG. 1), so that one face thereof is the N-pole and the other face is the S-pole. The inner yokes 14a and 14b are made of a magnetic material, and a circumferential face of a flange section 14c, which is extended like a short cylinder from an edge of each of the inner yokes 14a and 14b, acts as a magnetic flux acting surface, to which magnetic flux from the magnet 12 works, on the movable member 10 side.

Next, a structure of a stator 16 will be explained with reference to FIG. 1. A cylinder having closed upper and lower ends is formed by fitting a cylindrical member 20, which is made of a nonmagnetic material (e.g., plastic, stainless steel), between an upper case 18a and a lower case 18b, which are made of a nonmagnetic material. The above described movable member 10 is accommodated in the cylindrical member 20 and capable of reciprocally moving therein. Note that, the cylinder may be formed by welding the cases 18a and 18b to each other.

The both ends of the cylinder are closed by the cases 18a and 18b, and pump chambers 22a and 22b are respectively formed between side faces of the movable member 10 and inner faces of the cases 18a and 18b. The movable member 10 is slid in a state of contacting an inner face of the cylindrical member 20 with air-tightly or liquid-tightly sealing. To improve sliding property of the movable member 10, outer circumferential faces of the inner yokes 14a and 14b may be coated with a lubricative and rust-resistant agent, e.g., fluorocarbon resin, DLC (Diamond Like Carbon), and a stopper, which prohibits the movable member 10 to turn in the circumferential direction, may be provided.

Note that, dampers (not shown) may be attached to end faces (inner faces) of the cases 18a and 18b. They may be attached to parts of the movable member 10, which contact end faces of the inner yokes 14a and 14b and inner faces of the cases 18a and 18b.

A check valve 24a for sucking and a check valve 26a for discharging are provided to an opening section of the upper case 18a corresponding to an upper end face of the cylinder so as to open and close the pump chamber 22a. A check valve 24b for sucking and a check valve 26b for discharging are provided to an opening section of the lower case 18b corresponding to the lower end face of the cylinder so as to open and close the pump chamber 22b. The check valve 24a or 24b for sucking and the check valve 26a or 26b are arranged, in direction opposite to each other, in each of the opening sections.

An inlet 32 for sucking the circulating fluid into the pump and an outlet 34 for discharging the fluid therefrom are formed in the upper case 18a. Flow paths 28a and 28b for sucking the fluid, which communicate the inlet 32 to the check valves 24a and 24b, are respectively formed in the cases 18a and 18b. Further, flow paths 30a and 30b for discharging the fluid, which communicate the outlet 34 to the check valves 26a and 26b, are respectively formed in the cases 18a and 18b.

In FIG. 1, electromagnetic coils 36a and 36b are fitted around the cylindrical member 20. The coils 36a and 36b are slightly separated each other in the axial direction of the cylinder, and they are symmetrically arranged with respect to an axial center of the cylindrical member 20. Axial lengths of the coils 36a and 36b are longer than strokes of the flange sections 14c of the inner yokes 14a and 14b. The coils 36a and 36b are wound in the opposite directions, and one electric power source makes electric currents in the opposite directions pass through the coils. By winding the coils 36a and 36b in the opposite directions, electromagnetic forces working to the electric currents passing through the coils 36a and 36b, which interlink the magnetic flux of the magnet 12, are overlapped, the overlapped force works to the movable member 10 as reactive force, and the reactive force acts as thrust force.

A cylindrical outer yoke 38 encloses the coils 36a and 36b. The outer yoke 38 is made of a magnetic material and provided to increase number of magnetic flux interlinking the coils 36a and 36b and effectively work the electromagnetic force to the movable member 10. Since the flange sections 14c are respectively extended, in the axial direction, from the edges of the inner yokes 14a and 14b, magnetic resistance of a magnetic circuit, in which the magnetic flux of the magnet 12 is introduced to the outer yoke 38, can be reduced. With this structure, total number of magnetic flux, which works from the movable member 10 to the outer yoke 38, are increased, the magnetic flux from the magnet 12 perpendicularly interlinks the electric currents passing through the coils 36a and 36b with respect to the axial direction, so that the thrust force in the axial direction can be effectively applied to the movable member 10. The movable member 10 of the present embodiment is relatively light with respect to the thrust force, so that the movable member can react at a high speed and an amount of discharging fluid can be increased.

When the cases 18a and 18b are assembled, the cylindrical member 20 is fitted in fitting grooves of the cases 18a and 18b, so that the coils 36a and 36b and the outer yoke 38 can be coaxially attached to the cylindrical member 20.

By passing the alternate currents through the coils 36a and 36b, the movable member 10 is reciprocally moved (in the vertical direction) by counteraction of the electromagnetic force generated by the coils 36a and 36b. The electromagnetic force working to the coils 36a and 36b moves the movable member 10 in one direction and the reverse direction by switching current directions of the electric currents passing through the coils 36a and 36b; the movable member 10 can be reciprocally moved, with a proper stroke, by controlling a time period of passing the electric currents through the coils 36a and 36b and the current directions.

Note that, a sensor for detecting a position of the movable member 10 in the cylinder may be provided so as to control the reciprocal movement of the movable member 10 on the basis of detection signals of the sensor. For example, a magnetic sensor for detecting the position of the movable member 10 may be provided outside of the cylindrical member 20, or a pressure-sensitive sensor may be provided to a damper, not shown, so as to detect a time point that the movable member 10 contacts the damper. In the electromagnetic pump of the present embodiment, the stroke of the movable member 10 is relatively short, but areas of the pump chambers 22a and 22b are relatively large, so that a fixed amount of flow can be secured by reciprocally moving the movable member 10 at a high speed.

In the above described electromagnetic displacement-type pump, by reciprocally moving the movable member 10 by the coils 36a and 36b, the fluid is sucked into one of the pump chambers 22a and 22b and discharged from the other alternately. Namely, in the state shown in FIG. 1, when the movable member 10 is moved downward, the check valve 24a is opened by fluid pressure so as to suck the fluid into the pump chamber 22a; the check valve 26b is simultaneously opened by fluid pressure so as to discharge the fluid from the pump chamber 22b. On the other hand, when the movable member 10 is moved upward, the check valve 26b is opened by fluid pressure so as to discharge the fluid from the pump chamber 22a; the check valve 24b is opened by fluid pressure so as to suck the fluid into the pump chamber 22b. By moving the movable member 10 in any directions, the fluid is sucked and discharged, so that pulsation of the fluid can be restrained and the fluid can be efficiently flowed.

A structure of the check valve, which is used as each of the check valves of the pump chambers 22a and 22b, will be explained with reference to FIGS. 2-5. Two of the check valves are provided to the pump chambers 22a and 22b, namely four check valves are provided, but the check valve 24b of the pump chamber 22b for sucking the fluid will be explained in the following description as an example.

In FIG. 2A, the check valve 24b has a valve body 40, which is moved to and away from a valve seat 41 only by pressure of the fluid flowing into the pump chamber 22b. With this structure, the pump can be downsized, and pressure loss of the fluid passing the valve body 40 can be reduced. In FIG. 2B, the valve body 40 includes a valve section 42 capable of seating onto the valve seat 41 so as to close the flow path and the stopper section 43 preventing the valve body 40 from flushing out by fluid pressure. The valve body 40 may be constituted by a plurality of parts including the valve section 41, which is capable of moving to and away from the valve seat 41, and other sections. In FIG. 2C, the valve body 40 has one axis (the stopper section 43 in the present embodiment) in parallel with the flow path of the fluid, and a planar outer profile thereof is formed into a circular shape with the axis as the center. A planar shape of the valve section 42 is formed into a ring shape (formed into a skirt-shape in section) with an axial hole 42a. Therefore, the shape of the valve body has no directional character, so that the valve body can be securely seated on the valve seat 41 and can close the valve even if the axis of the valve body 40, which is moved to open by pressure variation of the fluid, is temporally inclined. Unlike ball valves, high manufacturing accuracy is not required, so that the pump chamber 22b with good sealing capability can be achieved with low cost; no parts repeatedly slid and deformed are used, so that the check valve 24b can be used for a prolonged period of time.

In FIG. 2B, the valve section 42 and the stopper section 43 of the valve body 40 are made of different materials or rubber materials having different hardness. Therefore, proper parts having required properties can be employed as the valve section 42 and the stopper section 43. Concretely, the valve section 42 of the valve body 40 may be made of a flexible material (e.g., plastic, elastomer, soft rubber), which is easily elastically deformed, so as to improve sealing property; the stopper section 43 may be made of a nonflexible material (e.g., plastic, hard rubber) so as to securely engage.

Since the check valve 24b is not closed by external force, its action is not securely settled when the alternate current is switched or the current is turned off. Thus, it is desirable to make average density (weight/volume) of the valve body 40 nearly equal to density of the used fluid, so that influences caused by gravity can be reduced and response of the valve can be improved. For example, preferable average density of the valve body 40 is 0.5-1.5 times as much as the density of the fluid.

In FIG. 2B, the axis of the stopper section 43 is fitted in the axial hole 42a of the valve section 42, and an end engage section 43a is engaged with an edge of the axial hole 42a, so that they are integrally assembled. In FIG. 2A, a guide section 44, which is capable of guiding the open-close action with aligning the axis of the stopper section 43 and a center of the fluid flow, is provided in the vicinity of an opening section of the valve seat 41. Since the guide section 44 guides the stopper section 43, the posture of the valve body 40 can be stabilized when the check valve 24b is opened and closed. By aligning the axis of the stopper section 43 and the center of the fluid flow sucked into the pump chamber 22b via the opening section, the action of the valve body 40 can be stabilized and characteristics of the pump can be improved.

Next, the check valve 24b having another structure will be explained.

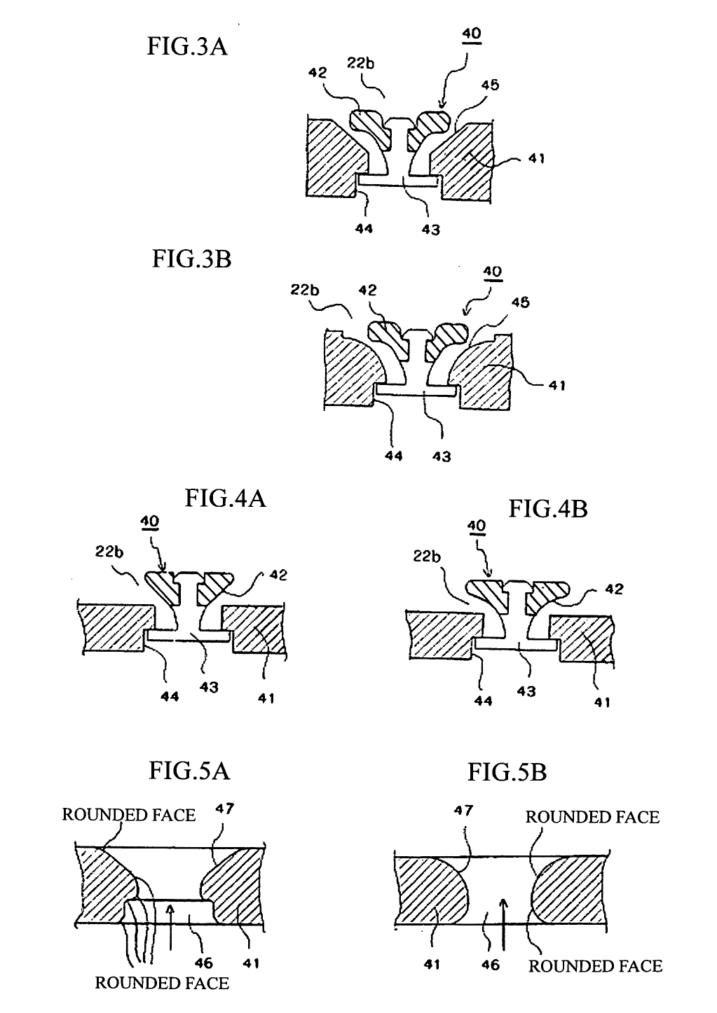

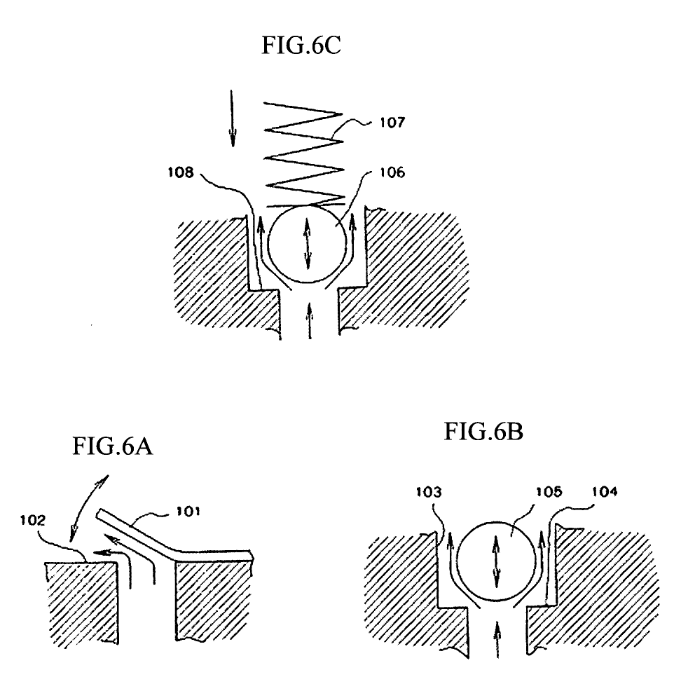

In FIG. 3A, a seat section 45 of the valve seat 41, to which the valve section 42 of the valve 40 is moved and from which the same is moved away, may have a tapered face, whose inner diameter is gradually increased toward the pump chamber 22b. In another case, as shown in FIG. 3B, the seat section 45 of the valve body 41 may have a rounded face, whose inner diameter is gradually increased toward the pump chamber 22b. In any check valves having the above described seat section 45, the valve section 42 of the valve body 40 is constituted by the relatively soft and flexible parts, so that the valve body can tightly fit the seat section 45, follow the shape thereof and maintain high sealing property.

In FIG. 4A, the valve section 42 of the valve body 40, which is moved to and away from the valve seat 41, may have a tapered face, whose outer diameter is gradually increased toward the pump chamber 22b. In another case, as shown in FIG. 4B, the valve section 42 of the valve body 40 may have a rounded face, whose outer diameter is gradually increased toward the pump chamber 22b.

In FIGS. 5A, a wall face 47 of a flow path formed in an opening section 46, to which the valve body 40 capable of moving to and away from the valve seat 41 is provided, is formed into a tapered face, whose inner diameter is gradually increased toward the pump chamber 22b, and a border section between faces constituting the opening section 46 is formed into a rounded face. In another case shown in FIG. 5B, the wall face 47 of the flow path formed in the opening section 46, to which the valve body 40 capable of moving to and away from the valve seat 41 is provided, is formed into rounded faces, whose inner diameters are gradually increased toward the pump chamber 22b and the sucking flow path 28b respectively. Since the wall face 47 of the flow path in the opening section 46 is formed into the tapered face or the rounded face without angular projections, the flow path is not extremely widened or narrowed so that pressure loss, which occurs at a widened or narrowed part, can be reduced.

The displacement-type pump of the present embodiment can be used for transporting a gas, water, nonfreeze liquid, etc., so type of fluid is not limited. Means for driving the pump is not limited to the electromagnetic means, the pump may be driven by, for example, a cylinder unit, etc. In case of using the pump for transporting fluid, if transporting pressure generated by one movable member 10 is too low, a multistage movable member, in which a plurality of movable member units each of which includes the movable member 10, the magnet 12 and the inner yokes 14a and 14b are connected, may be employed. By connecting a plurality of the movable member units, the movable member 10 having great thrust force can be realized and the electromagnetic displacement-type pump capable of generating a prescribed transporting pressure can be produced.

Further, yokes made of a magnetic material may be provided to axial end faces of the electromagnetic coils 26a and 26b. In this case, a magnetic circuit is formed between the yokes provided to the axial end faces of the coils 26a and 26b and the outer yoke 38, so that leakage flux can be reduced, magnetic flux can be effectively used, number of magnetic flux, which is interlinked by applying electricity to the coils 26a and 26b, can be securely increased, and pump efficiency can be improved.

1. A check valve for a displacement-type pump, in which a movable member is reciprocally moved in a pump chamber so as to repeatedly discharging and sucking fluid, characterized in,
that said check valves are arranged in direction opposite to each other on the fluid discharge side and the fluid suction side of the pump chamber, that valve bodies are opened and closed only by pressure of the fluid flowing into or flowing out from the pump chamber, that each of the valve bodies has one axis in parallel with a flow path of the fluid, and that a planar outer profile of the valve body is formed into a circular shape with the axis as the center.

2. The check valve according to claim 1, wherein the valve body includes: a valve section being capable of seating onto a valve seat so as to close the flow path; and a stopper section preventing the valve body from disengaging from the valve seat by the fluid pressure.

3. The check valve according to claim 1, wherein the valve body is constituted by a plurality of parts including a valve section, which is capable of moving to and away from a valve seat, and other sections.

4. The check valve according to claim 1, wherein a valve section and a stopper section of the valve body are made of different materials or rubber materials having different hardness.

5. The check valve according to claim 1, wherein a guide section, which is capable of guiding the open-close action with aligning an axis of a stopper section and a center of the fluid flow, is provided in the vicinity of an opening section of a valve seat.

6. The check valve according to claim 1, wherein the valve body is moved to and away from a seat section of a valve seat, and the seat section has a tapered face or a rounded face.

7. The check valve according to claim 1, wherein a valve section of the valve body, which is moved to and away from a valve seat, has a tapered face or a rounded face.

8. The check valve according to claim 1, wherein a wall face of an opening section of the pump chamber, to which the valve body is provided, is formed into a tapered face or a rounded face.
